(19) United States
(12) Patent Application Publication
(10) Pub. No.: US 2017/0248470 A1
(43) Pub. Date: Aug. 31, 2017

(54) DEVICE AND METHOD FOR CALIBRATING DISPLAY DEVICE

(71) Applicant: HON HAI PRECISION INDUSTRY CO., LTD., New Taipei (TW)

(72) Inventors: DING-HSIANG PAN, New Taipei (TW); SHUN-CHUAN YANG, New Taipei (TW)

(21) Appl. No.: 15/403,276

(22) Filed: Jan. 11, 2017

(30) Foreign Application Priority Data
Feb. 25, 2016 (CN) 201610100397.0

(51) Int. Cl. G01J 3/50; G01J 3/51; G01J 3/02

(52) U.S. Cl. CPC G01J 3/506; G01J 3/0251; G01J 3/501; G01J 3/51; G01J 3/0297

(57) ABSTRACT

A calibration device for calibrating output of a display device includes a light source, an integrating sphere, a filter, a narrowband instrument, a wideband instrument, and a data processing unit. The light rays emitted by the light source passing through the filter and enter the integrating sphere. The narrowband instrument and the wideband instrument are configured to measure the color measured data. The data processing unit is configured to receive the color measured data to generate a calibration matrix based on the color measured. The calibration matrix is used to calibrate the output from the wideband instrument.

### FIELD

The subject matter herein generally relates to a device and a method for calibrating display device.

### BACKGROUND

Calibrating display devices is generally done using a color measurement instrument. Color measurement instruments can be divided into two types, wideband and narrowband. The wideband instrument is usually chosen as the first priority for display device testing because the wideband instrument is not only cheap but also faster than other calibrating methods at data reading. However, the signal measured by the wideband instrument is an approximate value compared with real tristimulus value. The approximate value may vary based upon the quality of the measuring device. Therefore, calibrating the spectrum measured by integrating the wideband instrument and the narrowband instrument at same time is helpful to enhance the calibration. In some cases, if the calibration spectrum of light source is not the same as the spectrum of the measured display device, the calibration parameters provided by the narrowband instrument are not accurate.

### BRIEF DESCRIPTION OF THE DRAWINGS

Implementations of the present technology will now be described, by way of example only, with reference to the attached figures.

FIG. 1 is a system diagram of a calibration device for calibrating a display device in accordance with aspects of the disclosure.

FIG. 2 is another system diagram of a calibration device for calibrating a display device in accordance with aspects of the disclosure.

FIG. 3 is a block diagram of calibrating a display device in accordance with aspects of the disclosure.

FIG. 4 is another block diagram of calibrating a display device in accordance with aspects of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” exemplary embodiment in this disclosure are not necessarily to the same exemplary embodiment, and such references mean “at least one.”

The term “comprising” means “including, but not necessarily limited to”; it specifically indicates open-ended inclusion or membership in a so-described combination, group, series and the like.

The present disclosure provides a device for calibrating and a method for calibrating display device.

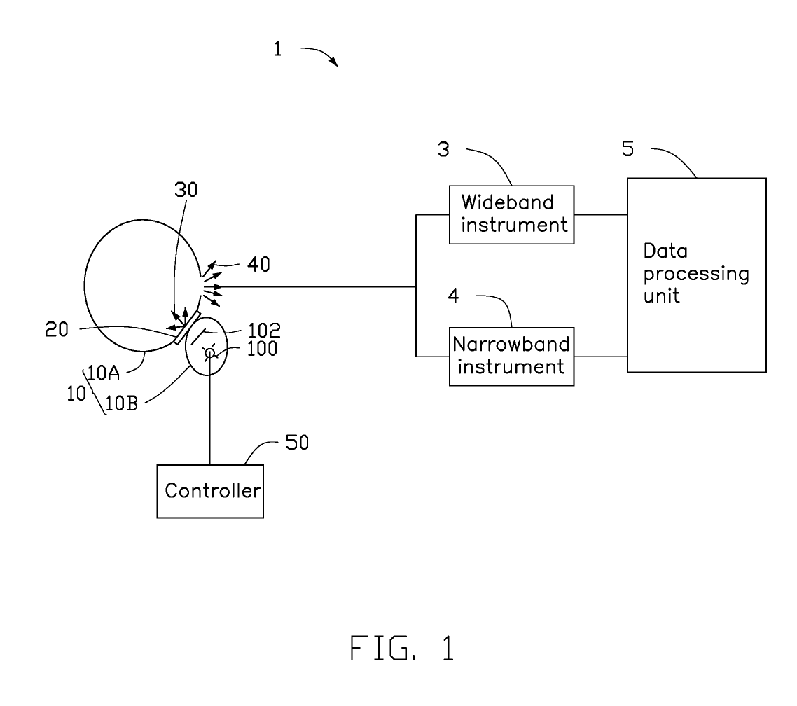

FIG.1 illustrates a systematic structure of a device 1 for calibrating display device. The device 1 comprises a light source 100, integrating spheres 10, a filter 20, a controller 50, a narrowband instrument 4, a wideband instrument 3, and a data processing unit 5.

The integrating spheres 10 are hollow spheres. The inner surface of the each sphere 10 is coated with a diffusing material. The diffusing material is substantially white as the diffusing coefficient of the white diffusing material is close to 1. When light enters the integrating sphere 10, the light can be reflected into multiple scatterings. The luminous flux on the inner surface then becomes uniform so that the spectrum of input light and the spectrum of output light are consistent. In some exemplary embodiments, the white diffusing material can be chosen from magnesium oxide or barium sulfate.

In some exemplary embodiments, the integrating spheres 10 comprise a large integrating sphere 10A and a smaller integrating sphere 10B. An entrance port 30 and an exit port 40 are provided on the surface of the larger sphere. For more accurate measuring, the ratio between the total area of the ports and the area of the inner surface of the sphere 10A is preferred to be as small as possible. The ratio between the total area of the entrance ports 30 and the surface area of the inner surface of the sphere 10A is as small as possible. The ratio between the total area of the output ports 40 and the surface area of the inner surface of the sphere 10A is as small as possible.

The light source 100 is inside the smaller integrating sphere 10B. The sphere 10B comprises a light shield 102. The light source 100 is coupled to the controller 50 and emits light. In some exemplary embodiments, the controller is an electronic device (e.g., computer, laptop, mobile phone). In some exemplary embodiments, the controller is a part of electronic device (e.g., microchip, processor).

In some exemplary embodiments, the light source 100 can be a Halogen lamp, a Xenon lamp, a light source with visible a continuous spectrum, or a light source with variable wavelength (the range of the wavelength being between 380 nm and 780 nm). The measurement instruments (narrowband instrument, wideband instrument or mixed instruments) are configured to measure the entire spectrum of a display device during testing. The light shield 102 can block the light rays of light source 100 emitted directly at the filter 20. The light shield 102 can also promote the exit of light rays of light source 100 from the integrating sphere 10 after multiple reflections of the light rays when they are in the integrating sphere 10.

In some exemplary embodiments, the filter 20 is provided at the entrance port 30 of the integrating sphere 10. The light rays from 10B pass through the filter 20 and then enter the integrating sphere 10A through the entrance port 30.

In some exemplary embodiments, to improve the quality (e.g., monochromicity, percentage saturation) of the light rays, stray light or interference from other environments is preferred to be prevented. Therefore, the exit port 40 of the integrating sphere 10 is modified by the light shield function so the performance (such as accuracy, stability) of the integrating sphere 10 is enhanced.

The spectrum of the measured display device is generated by a multiplication of the spectrum of the light source 100 and the spectrum of the filter 20, which means that the spectrum of the filter is equal to the spectrum of the display device divided by the spectrum of the light source. The spectrum of the filter 20 can be acquired by (1) measuring the spectrum of the measured display device; (2) measuring the spectrum of the light source 100; and (3) dividing the spectrum of the measured display device by the spectrum of the light source 100.

To measure the spectrum of the measured display device, the process includes:

(1) the light rays emitted from the light source 100 first to pass through the filter 20;

(2) the light rays to enter the integrating sphere 10A;

(3) the light rays to be emitted from the exit port 40; and

(4) the spectrum of the light rays to be measured.

In some exemplary embodiments, the display device can be chosen from liquid-crystal display (LCD), light emitting diode (LED), organic light emitting diode (OLED), or any display device emitting light.

The data processing unit 5 processes data as to the information in the exemplary embodiments mentioned above. The data processing unit can be a microchip, a processor, personal computer, a server, or a portable device (such as laptop, mobile phone, and tablet).

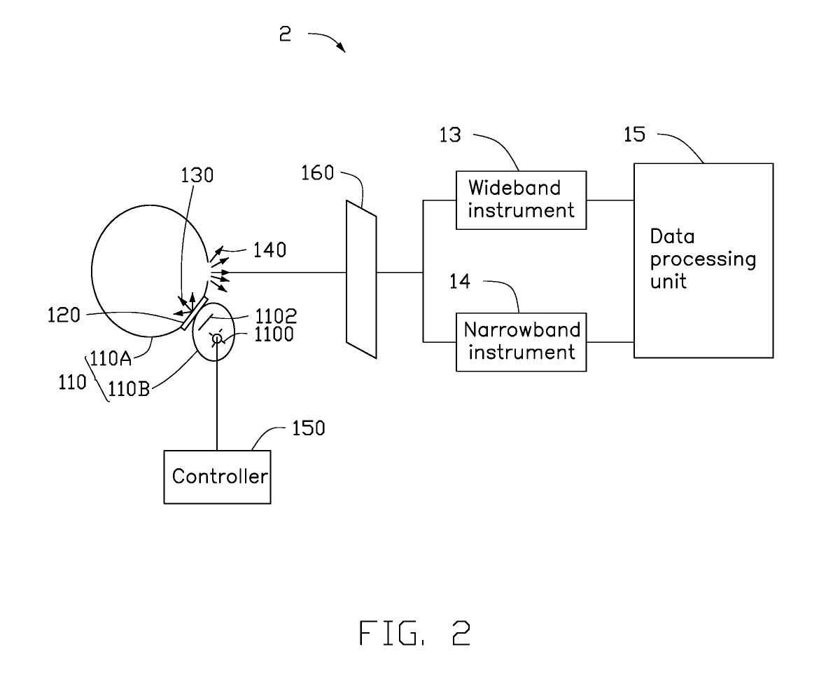

FIG. 2 illustrates another exemplary structure of a device 2 for calibrating a display device. The device 2 comprises a light source 1100, integrating spheres 110, a filter 120, a diffuser 160, a controller 150, a narrowband instrument 14, a wideband instrument 13, and a data processing unit 15.

In some exemplary embodiments, the integrating spheres 110 comprise a large integrating sphere 110A and a smaller integrating sphere 110B. An entrance port 130 and an exit port 140 are provided on the surface of the large sphere 110A.

The light source 1100 is inside the sphere 110B. The sphere 110B comprises a light shield 1102. The light source 1100 is coupled to the controller 150 to emit light rays. In some exemplary embodiments, the controller is an electronic device (e.g., computer, laptop, mobile phone). In some exemplary embodiments, the controller is a part of electronic device (e.g., microchip, processor).

In some exemplary embodiments, the light source 1100 can be one of a Halogen lamp, a Xenon lamp, a light source with visible continuous spectrum, or a light source with variable wavelength (the range of the wavelength being between 380 nm and 780 nm). The measurement instruments (narrowband instrument or wideband instrument) are configured to measure entire spectrum of a display device during testing. The light shield 1102 is configured to block the light rays of light source 1100 emitted directly at the filter 120. The light shield 1102 is also configured to promote the exit of the light rays of light source 1100 from the integrating sphere 110B after multiple reflections in the integrating sphere 110B.

In some exemplary embodiments, the filter 120 is provided at the entrance port 130 of the integrating sphere 110A. The light rays emitted by the light source 1100 in the integrating sphere 110B pass through the filter 120 and then enter the integrating sphere 110A through the entrance port 130.

In some exemplary embodiments, to improve the quality of the light rays, stray light or interference from other environments is prevented. Therefore, the exit port 140 of the integrating sphere 110A is modified by the light shield 1102 so that the performance of the integrating sphere 110A is enhanced.

The spectrum of the measured display device is generated by a multiplication of the spectrum of the light source 100 and the spectrum of the filter 20. The spectrum of the filter 20 can be acquired by (1) measuring the spectrum of the measured display device; (2) measuring the spectrum of the light source 100; and (3) dividing the spectrum of the measured display device by the spectrum of the light source 100.

To measure the spectrum of the measured display device, the process includes:

(1) the light rays emitted from the light source 1100 first to pass through the filter 120;

(2) the light rays to enter the integrating sphere 110A;

(3) the light rays to be emitted from the exit port 140; and

(4) the spectrum of the light rays to be measured.

In some exemplary embodiments, the display device can be chosen from liquid-crystal display (LCD), light emitting diode (LED), organic light emitting diode (OLED), or any display device emitting light.

The diffuser 160 is provided at/near the exit port 140. The aperture of the exit port is small so that the light rays emitted from the integrating sphere 110 can be considered as a light point (or dot) when passing through the exit port 140. When the light point is expanded to a light surface, the light surface is not uniform because the light has higher intensity at the center than at the periphery. Therefore, the diffuser 160 is configured to improve the light uniformity and help to create a uniform surface light source. The surface light source provides a proper spectrum to fit the spectrum of the measured display device.

The data processing unit 15 is configured to do data processing according to the information in the exemplary embodiments mentioned above. The data processing unit can be a personal computer, a server, or a portable device (such as laptop, mobile phone, and tablet).

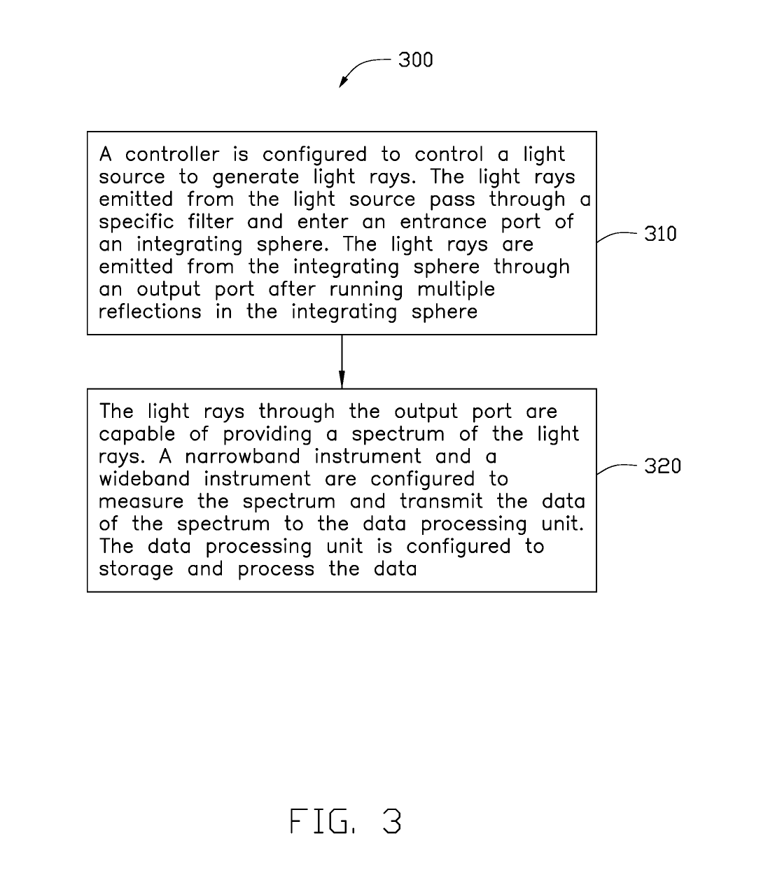

A calibration method for a display device is also provided according to the present disclosure. The calibration method comprises block diagram 300 as shown in FIG. 3:

In block 310, a controller 150 is configured to control a light source 1100 to generate light rays. The light rays emitted from the light source 1100 pass through a filter 120 and enter an entrance port 130 of an integrating sphere 110. The light rays are emitted from the integrating sphere 110 through an exit port 140 after running multiple reflections in the integrating sphere 110.

In block 320, the light rays through the exit port 140 are capable of providing a spectrum of the light rays. A narrowband instrument 14 and a wideband instrument 13 are configured to measure the spectrum and transmit the data of the spectrum to the data processing unit 15. The data processing unit 15 is configured to storage and process the data.

The narrowband instrument 14 is usually configured to measure and record the reflectivity and the emissivity of the spectrum of the visible light with an incremental range between 1 and 10 nanometers. Therefore, 30 to 200 channels can be measured, and the trichromatic coefficient can be calculated. In some exemplary embodiments, the narrowband instrument 14 can be chosen from spectrometer and spectroscope.

The wideband instrument 13 is usually configured to measure at least three color signals passing through a wideband filter. In some exemplary embodiments, the wideband instrument 13 can be chosen from spectrophotometer, photodensitometer, and chromatometer.

In some exemplary embodiments, the narrowband instrument 14 is configured to measure one measured value (X0, Y0, Z0). The wideband instrument 13 is configured to measure another measured value (X1, Y1, Z1).

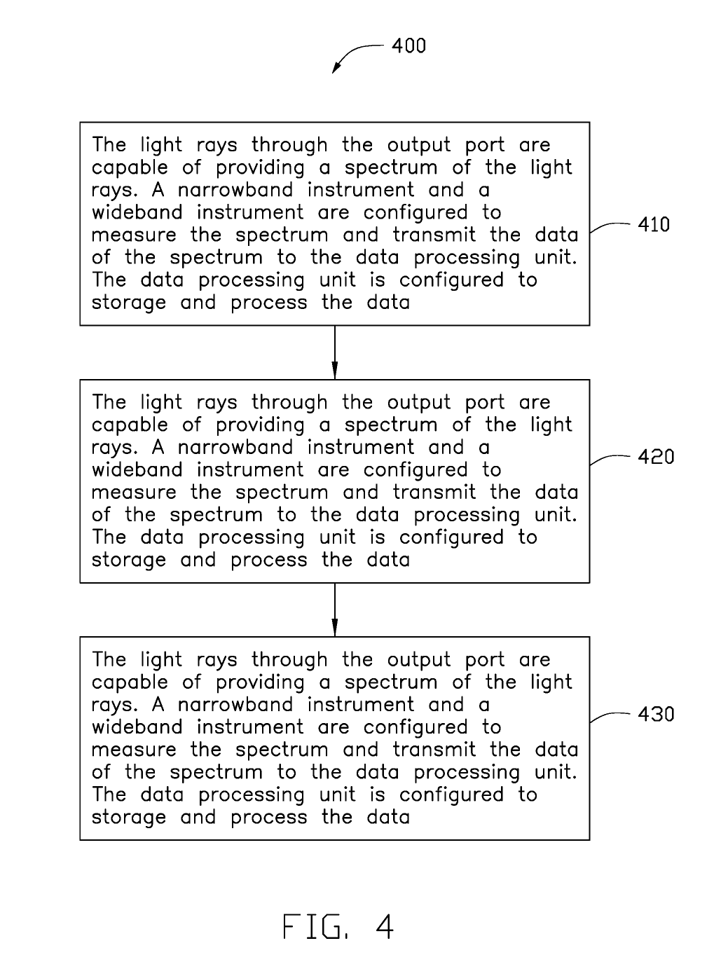

In some exemplary embodiments, the calibration method can be modified, and the modified method comprises block diagram 400 as shown in FIG. 4:

In block 410, a controller 150 is configured to control a light source 1100 to generate light rays. The light rays from the light source 1100 pass through a filter 120 and enter an entrance port 130 of an integrating sphere 110. The light rays are emitted from the integrating sphere 110 through an exit port 40 after running multiple reflections in the integrating sphere 110.

In block 420, the light rays through the exit port 140 are capable to provide a spectrum of the light rays. A narrowband instrument 14 and a wideband instrument 13 are configured to measure the color measured data (such as spectrum) and transmit the data to the data processing unit 15. The data processing unit 15 is configured to storage and process the data.

In block 430, the data processing unit 15 is configured to generate a calibration matrix for color measured data. The calibration matrix is used to calibrate the measured output from the wideband instrument 13.

The measured value (X1, Y1, Z1) usually has a higher probability of error, and the measured value (X0, Y0, Z0) usually has a smaller probability of error. The data processing unit 15 is configured to integrate the measured value (X1, Y1, Z1) and the measured value (X0, Y0, Z0) to generate with calibrating parameters AX,AY,AZ. The calibrating parameters AX,AY,AZ can be calculated by equations (1-1), (1-2) and (1-3) as follows:

AX=X0/X1 (1-1)

AY=Y0/Y1 (1-2)

AZ=Z0/Z1 (1-3)

The measured value (X2, Y2, Z2) measured by the wideband instrument 13 can be calibrated by the data processing unit 5 as follow equations:

X2=X1*AX (2-1)

Y2=Y1*AY (2-2)

Z2=Z1*AZ (2-3)

The present disclosure is applied to any calibration devices and calibration methods for display device. The present disclosure is suitable for any spectrum related test or measurement on different display devices. The present disclosure also provides a solution without following the traditional measure method which needs to comply with the spectrum distribution policy of Commission Internationale Ed I'eclairage (CIE).

The exemplary embodiments shown and described above are only examples. Many details are often found in the art such as the other features of a vehicle scheduling device and method for transportation system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A calibration device for calibrating a display device comprising:
a light source to emit light rays;
an integrating sphere;
a filter;
a narrowband instrument; and
a wideband instrument,
wherein the light source is provided inside the integrating sphere, the filter is provided at an exit port of the integrating sphere;
wherein the spectrum of the filter is equal to the spectrum of the display device divided by the spectrum of the light source; and
wherein the narrowband instrument and the wideband instrument measure a color measured data based on the light rays emitted from the exit port of the integrating sphere.

2. The calibration device of claim 1, further comprises a data processing unit coupled to the narrowband instrument and the wideband instrument, wherein the data processing unit is configured to receive the color measured data to generate a calibration matrix, and the calibration matrix calibrates the wideband instrument.

3. The calibration device of claim 1, further comprises a diffuser, wherein, the diffuser is provided at the output port, the light rays emit from the output port, the light rays project on the diffuser, and the narrowband instrument and the wideband instrument are configured to measure the color measured data from diffused light rays emitted by the diffuser.

4. The calibration device of claim 1, further comprises a controller, and the controller is coupled to the light source and configured to control the light source to emit the light rays.

5. The calibration device of claim 1, further comprises a light shield in the integrating sphere, and the light shield is configured to block the light rays of light source emitted at the filter directly.

6. A calibration device for calibrating a display device comprising:
a light source;
a first integrating sphere;
a second integrating sphere;
a filter;
a narrowband instrument; and
a wideband instrument,
wherein the light source is provided inside the first integrating sphere, the filter is provided at an entrance port of the second integrating sphere and an exit port of the first integrating sphere;
wherein the light rays pass through the filter and enter the second integrating sphere from the first integrating sphere;
wherein the spectrum of the filter is equal to the spectrum of the display device divided by the spectrum of the light source; and
wherein the narrowband instrument and the wideband instrument measure a color measured data based on the light rays emitted from the exit port of the second integrating sphere.

7. The calibration device of claim 6, wherein the calibration device further comprises a data processing unit coupled to the narrowband instrument and the wideband instrument, wherein the data processing unit is configured to receive the color measured data to generate a calibration matrix, and the calibration matrix calibrates the measured output from the wideband instrument.

8. The calibration device of claim 6, further comprises a diffuser, wherein the diffuser is provided at the output port, the light rays emit from the output port, the light rays project on the diffuser, and the narrowband instrument and the wideband instrument are configured to measure the color measured data from diffused light rays emitted by the diffuser.

9. The calibration device of claim 6, further comprises a controller, and the controller is coupled to the light source and configured to control the light source to emit the light rays.

10. The calibration device of claim 6, further comprises a light shield in the first integrating sphere, and the light shield is configured to block the light rays of light source emitted at the filter directly.

11. The calibration device of claim 6, wherein the light source with variable wavelength is about 380 nm to about 780 nm.

12. The calibration device of claim 6, wherein the first integrating sphere is a small integrating sphere, the second integrating sphere is a larger integrating sphere, and the light source is inside the small integrating sphere.

13. The calibration device of claim 6, wherein the narrowband instrument is configured to measure and record the reflectivity and the emissivity of the spectrum of the visible light with an incremental range about 1 to about 10 nm.

14. The calibration device of claim 6, wherein the wideband instrument is configured to measure at least three color signals passing through a wideband filter.

15. A calibration method for calibrating a display device performed by a calibration device comprising the steps of:
a) generating a filter that the spectrum of the filter is equal to the spectrum of the display device divided by the spectrum of the light source;
b) measuring a color measured data by a narrowband instrument and a wideband instrument after the light rays emitted passed through the filter; and
c) calibrating a measured output through a calibration matrix based on the color measured data from the wideband instrument.

16. The calibration method of claim 15, further comprises the step: diffusing light rays from the light source through a diffuser.

17. The calibration method of claim 15, further comprises a controller, and the controller is coupled to the light source and is configured to control the light source to emit the light rays.

18. The calibration method of claim 16, wherein the diffuser is configured to create a uniform surface light source when the light rays is diffused by the diffuser.

19. The calibration method of claim 15, further comprises a light shield in the integrating sphere, and the light shield is configured to block the light rays of light source emitted at the filter directly.
